(19) United States
(12) Patent Application Publication
(10) Pub. No.: US 2012/0090442 A1
(43) Pub. Date: Apr. 19, 2012

(54) GLASS CUTTING DEVICE

(75) Inventor: SHAO-KAI PEI, Tu-Cheng (TW)

(73) Assignee: HON HAI PRECISION INDUSTRY CO., LTD., Tu-Cheng (TW)

(21) Appl. No.: 12/978,623

(22) Filed: Dec. 26, 2010

(30) Foreign Application Priority Data
Oct. 13, 2010 (TW) 99134987

(51) Int. Cl. B26D 7/18; B26D 7/06

(52) U.S. Cl. 83/123; 83/167

(57) ABSTRACT

A glass cutting device includes a cutter, a driver, and an ejector. The cutter includes a connection tube, an annular blade base, and a blade. The annular blade base extends outward from an end of the connection tube along a direction substantially parallel to a radial direction of the connection tube. The blade extends from a surface of the blade base opposite to the connection tube along a direction substantially perpendicular to the radial direction of the connection tube. The driver drives the connection tube to spin and move toward a glass substrate to cut a circular glass from the glass substrate by the blade. The ejector is received in the connection tube and ejects the circular glass from the glass substrate.

### BACKGROUND

1. Technical Field

The present disclosure relates to a glass cutting device.

2. Description of Related Art

Current glass cutting devices can cut a circular glass from a glass substrate. However, the cut circular glass often remains in the glass substrate and therefore needs to be manually separated from the glass substrate, which is inconvenient and inefficient.

Therefore, it is desirable to provide a glass cutting device, which can overcome the limitations described.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is an isometric, schematic view of a glass cutting device, according to an embodiment.

FIG. 2 is a cross-sectional view of the glass cutting device taken along a line II-II of FIG. 1.

### DETAILED DESCRIPTION

Embodiments of the present disclosure will now be described in detail with reference to the drawings.

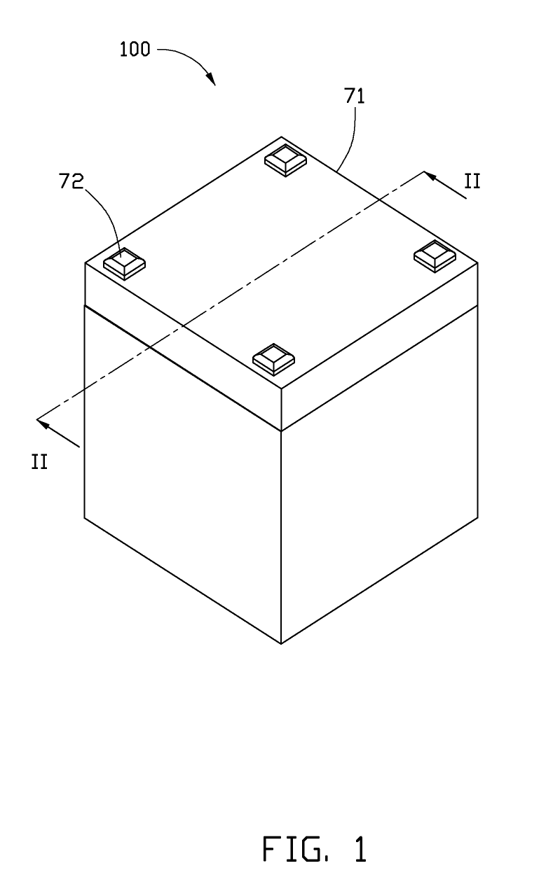

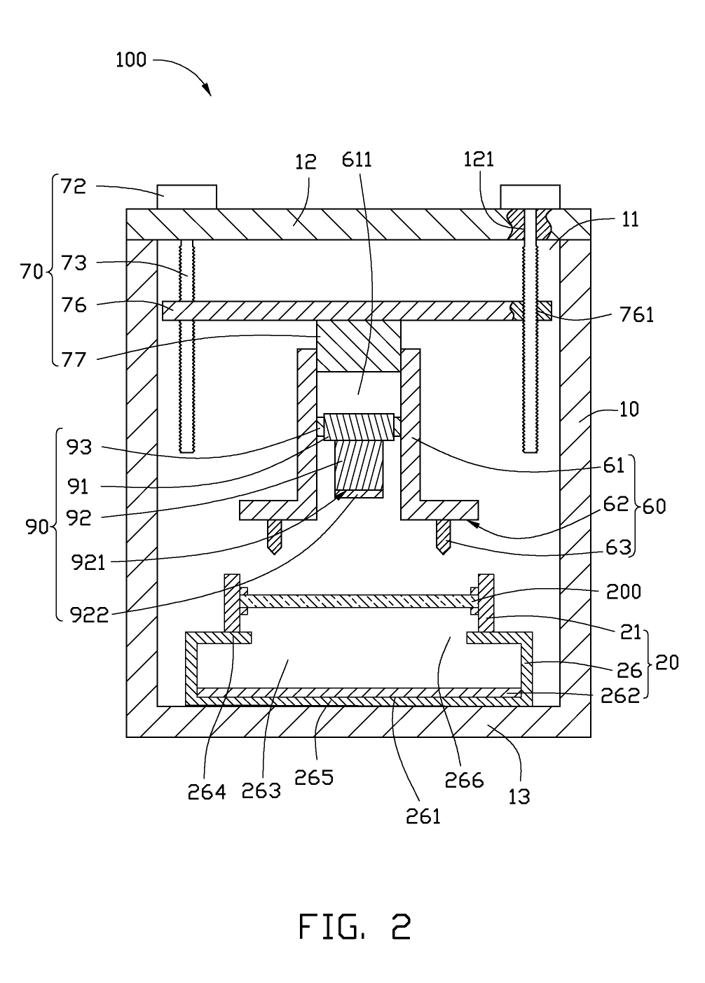

Referring to FIGS. 1-2, a glass cutting device 100, according to one embodiment, is configured for cutting a circular glass (not shown) from a glass substrate 200. The glass cutting device 100 includes a housing 10, a holder 20, a cutter 60, a driver 70, and an ejector 90.

The housing 10 is substantially a hollow cuboid in shape and defines a generally cubic receiving cavity 11 therein. The housing 10 includes a top plate 12, above the receiving cavity 11, and a bottom plate 13 opposite to the top plate 12, under the receiving cavity 11. The top plate 12 defines four through holes 121 therethrough, generally at four corners thereof.

The holder 20 is configured for holding the glass substrate 200 and collecting the circular glass. In particular, the holder 20 includes a container 26, a holding sleeve 21, and a buffer layer 262. The container 26 is substantially a hollow cuboid in shape and defines a generally cubic collection cavity 263 therein. The container 26 includes an upper plate 264, above the collection cavity 263, and a lower plate 265 opposite to the upper plate 264, under the collection cavity 263. The upper plate 264 defines an opening 266 generally at the center thereof and allows the collection cavity 263 to be accessed from outside. The lower plate 265 includes an upper surface 261. The holding sleeve 21 is a tube in shape and disposed on the upper plate 264, surrounding the opening 266. The buffer layer 262, such as a rubber or sponge layer, is disposed on the upper surface 261.

The cutter 60 includes a connection tube 61, a blade base 62, and a blade 63. The blade base 62 is an annular plate extending outward from an end of the connection tube 61 along a direction substantially parallel to a radial direction of the connection tube 61. The blade 63 extends downward from a surface of the blade base 62 opposite to the connection tube 61 and along a direction substantially perpendicular to the radial direction of the connection tube 61.

The driver 70 includes four first motors 72, four threaded bolts 73, a connection board 76, and a second motor 77. The connection board 76 defines four threaded holes 761 corresponding to the four through holes 121. The four threaded bolts 73 screw through the respective threaded holes 761 and thus threadedly engage with the connection board 76. The second motor 77 is secured to a surface of the connection board 76, generally at the center thereof.

The ejector 90 includes a cylinder 91, a piston rod 92, a connection sleeve 93, and a second buffer layer 922. The piston rod 92 extends out from the cylinder 91 and can be driven by the cylinder 91 to move back and forth relative to the cylinder 91. The connection sleeve 93, such as an adhesive tape, sleeves on the cylinder 91 and connects the cylinder 91 to the connection tube 61 (see below). The piston rod 92 includes an end surface 921 opposite to the cylinder 91. The second buffer layer 922, such as a rubber or sponge layer, is disposed on the end surface 921.

In assembly, excepting the first motors 72 and the threaded bolts 73, the holder 20, the cutter 60, the driver 70, and the ejector 80 are received the receiving cavity 11. The holder 20 is received in the receiving cavity 11 and disposed on the bottom plate 13, generally at the center thereof, such that the lower plate 265 contacts the bottom plate 13. The cutter and the ejector 90 are also received in the receiving cavity 11. The ejector 90 is received in the connection tube 61 and connected to the connection tube 61 by the connection sleeve 93. The piston rod 92 can be driven by the cylinder 91 to eject out of the connection tube 61 by the end of the connection tube 61 where the blade base 62 extends. The four first motors 72 are disposed on the top plate 12 corresponding to the respective through holes 121. The threaded bolts 73, the connection board 76, and the second motor 77 are received in the receiving cavity 11. The threaded bolts 73 extend through the respective threaded holes 761, the respective through holes 121 and couple to the respective first motors 72 such that the threaded bolts 73 can be driven by the respective first motors 72 to spin. The connection tube 61 is coupled to the second motor 77 such that the connection tube 61 can be driven by the second motor 77 to spin.

In operation, the glass substrate 200 is held in the holding sleeve 21. The second motor 77 drives the connection tube 61 to spin and the first motors 72 drive the respective threaded bolts 73 to spin. Thus, the cutter 60 spins and moves toward the glass substrate 200 and thus cuts the circular glass from the glass substrate 200. After the circular glass is cut, the piston rod 91 is driven by the cylinder 91 to eject the circular glass to separate from the glass substrate 200 and the circular glass falls into the collection cavity 263.

The number of the blades 63 is not limited to one. When employing more than one blade 63, the blades 63 are arranged such that the distances between the respective blade and the central axis of the connection tube 61 are identical.

The first motors 72, the through holes 121, and the threaded holes 761 are not limited to four but can be changed depending on need. In other embodiments, the top plate 12 can define only two through holes 121, the connection board 76 can define only two corresponding threaded holes 761, and the driver 70 includes only two first motors 72 and two threaded bolts.

The first buffer layer 262 and the second buffer layer 922 are used to buffer the impact on the circular glass by the lower plate 265 and the piston rod 92. In other embodiments, if the impact is acceptable, the first buffer layer 262 and the second buffer layer 922 can be omitted.

The cylinder 91 can be connected to the connection tube 61 by other technologies in other embodiments.

The housing 10 is used to provide a working space for the cutting and in other embodiments can be omitted, if not needed. The holder 20 can be omitted to depending on need.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. A glass cutting device comprising:
a cutter comprising:
a connection tube;
an annular blade base extending outward from an end of the connection tube along a direction substantially parallel to a radial direction of the connection tube; and
a blade extending from a surface of the blade base opposite to the connection tube along a direction substantially perpendicular to the radial direction of the connection tube;
a driver configured for driving the connection tube to move toward a glass substrate and driving the connection tube to spin such that the blade cuts a circular glass from the glass substrate; and
an ejector received in the connection tube and configured for ejecting the circular glass from the glass substrate.

2. The glass cutting device of claim 1, further comprising another blade, wherein the distance between each blade and a central axis of the connection tube is identical.

3. The glass cutting device of claim 1, wherein the driver comprises two first motors, two threaded bolts, a connection board, and a second motor; the connection board defines two threaded holes, the two threaded bolts screw through the respective threaded holes, the second motor is secured to the connection board and coupled to the connection tube to drive the connection tube to spin; the first motors are configured for driving the respective threaded bolts to spin and thus driving the connection board along with the cutter to move toward the glass substrate by the threaded engagement of the threaded bolts with the threaded holes.

4. The glass cutting device of claim 1, wherein the ejector comprises a cylinder and a piston rod, the cylinder is received in and connected to the connection tube, the piston rod extends from the cylinder; the cylinder is configured for driving the piston rod to come out of the connection tube via the end of the connection tube where the blade base extends.

5. The glass cutting device of claim 4, wherein the ejector comprises a connection sleeve, the connection sleeve sleeves on the cylinder and is configured for connecting the cylinder to the connection tube.

6. The glass cutting device of claim 5, wherein the connection sleeve comprises an adhesive tape.

7. The glass cutting device of claim 4, wherein the ejector comprises a buffer layer, the buffer layer is positioned on an end surface of the piston rod opposite to the cylinder.

8. The glass cutting device of claim 7, wherein the buffer layer is selected from the group consisting of a rubber layer and a sponge layer.

9. The glass cutting device of claim 1, further comprising a housing, the housing defining a receiving cavity therein, wherein the cutter, the driver, and the ejector are received in the housing.

10. The glass cutting device of claim 9, wherein the housing comprises a top plate above the receiving cavity and a bottom plate under the cavity, the top plate defines two through holes, the driver comprises two first motors, two threaded bolts, a connection board, and a second motor; the connection board defines two threaded holes, the two threaded bolts screw through the respective threaded holes and extend through the respective through holes, the second motor is secured to the connection board and coupled to the connection tube to drive the connection tube to spin; the first motors are positioned on the top plate and couple to the respective threaded bolts to drive the respective threaded bolts to spin and thus drive the connection board along with the cutter to move toward the glass substrate by the threaded engagement of the threaded bolts with the threaded holes.

11. The glass cutting device of claim 1, further comprising a holder, the holder being configured for holding the glass substrate and collecting the circular glass.

12. The glass cutting device of claim 11, wherein the holder comprises a container and a holding sleeve, the container defines a collection cavity therein for collecting the circular glass, the container comprises an upper plate, above the collection cavity, and a lower plate opposite to the upper plate, under the collection cavity, the upper plate defines an opening communicating the collection cavity with outside, the holding sleeve is positioned on the upper plate, surrounds the opening and is configured for holding the glass substrate.

13. The glass cutting device of claim 12, wherein the holder comprises a buffer layer, the buffer layer is received in the collection cavity and positioned on the lower plate.

14. The glass cutting device of claim 13, wherein the buffer layer is selected from the group consisting of a rubber layer and a sponge layer.

15. The glass cutting device of claim 11, further comprising a housing, the housing defining a receiving cavity therein, wherein the holder are received in the housing.

16. The glass cutting device of claim 15, wherein the housing comprises a top plate above the receiving cavity and a bottom plate under the cavity, the holder is positioned on the bottom plate.
